(19) United States
(12) Patent Application Publication
(10) Pub. No.: US 2007/0275121 A1
(43) Pub. Date: Nov. 29, 2007

(54) Dry Mixtures for Making Dough for Bread and Methods for Production Thereof

(76) Inventor: Jytte Malby, Rudkobing (DK)

Correspondence Address: Licata & Tyrrell P.C., 66 E. Main Street, Marlton, NJ, 08053, US

(21) Appl. No.: 11/753,705

(22) Filed: May 25, 2007

(30) Foreign Application Priority Data
May 29, 2006 (DK) PA2006 00725

(51) Int. Cl. A21D 8/02

(52) U.S. Cl. 426/19

(57) ABSTRACT

Dry mixture compositions and methods for preparation of bread are provided. The dry mixture compositions and methods are particularly useful in easy, rapid and inexpensive preparation of wholesome and nourishing gluten-free bread.

This patent application claims the benefit of priority from provisional Danish patent application No. PA2006 00725, filed May 29, 2006, teachings of which are herein incorporated by reference in their entirety.

### FIELD OF THE INVENTION

The present invention relates to new bread comprising ground flour, preferably naturally gluten-free flour, produced from a dry mix of selected powdered materials comprising foam forming material, and yeast, and a gel-forming plant material.

### BACKGROUND OF THE INVENTION

Recipes and methods for preparing home-baked, gluten-free bread are widely known. Gluten-free wheat flour composed of wheat starch is commercially available. Commercial products containing of brown rice, buckwheat, maize flour, corn starch, sugar beet, psyllium seed bran, and/or potato starch are available. Bread made of this material is produced via similar process to normal, gluten-containing bread.

In general, the dough to make gluten-free bread is heavy and time-consuming to handle. Further, the end product is considerably different from normal bread in appearance and consistency.

In addition, gluten-free bread is considerably more expensive that normal bread. This may be due to the fact that products are specialized for supplying a relatively small demand to only a few consumers. In addition, the raw materials used are considerably more expensive than those used for ordinary bread as gluten-free flour, and especially naturally occurring forms of suitable gluten-free flour, are expensive.

WO2004080186 discloses a method of making gluten-free bread from partitioned portions of the ingredients as dough and flour mixture. In this method bread is made from non-waxy rice as the main material. The process comprises a first step of mixing a 4 to 8 parts by mass portion (referring the total amount of rice flour obtained from non-waxy rice as to 100 parts by mass) of rice flour with 10 to 15 times as much water and heating the mixture to gelatinize starch in the rice flour to give a viscous slurry. In a subsequent step, the slurry is mixed with the remainder of the rice flour and water in an amount 0.1 to 0.2 times as much as the remainder of the rice flour. Yeast is then added to yield free flowing bread dough. The bread dough mixture is then poured into a mold and warmed to allow fermentation. The fermented dough is then baked in an oven. The bread thus obtained is substantially free from gluten. The procedure does not involve the partitioning of the components into two dry portions as the first portion is premixed with water to form a viscous binder whereupon the remainder of the rice is added together with more water and yeast.

EP Patent 0642737 describes gluten-free bread produced from gluten-free flour and eggs and optionally baking powder and baker's yeast. Wheat flour is used together with egg albumin, and optional additions of butter fat. No water or other liquids are added. The mixture is whipped to foam in the course of 5 to 30 minutes and left to ferment and rise in the course of 12 hours during which time the vole increases threefold. The egg bound mass is subsequently baked to form a loaf which resembles ordinary bread.

Canadian Patent 2412511 discloses a gluten-free bakery process for preparing gluten-free bread which involves mixing water with a dry mix to form dough, shaping the dough into units for baking, proofing the shaped units, and baking. The dry mix comprises flour, 0.5% quick-leavening active dry yeast and dough conditioners selected from a mixture of gums. The process involves a proving stage of about 45 minutes where fermentation is initiated. About 300 ml of water is added to form dough of about 600 grams and a bread of about 490 grams, when baked, and a density of about 0.22 g/ml to about 0.25 g/ml. The process is used for preparing gluten-free bread wherein the flour comprises a blend of soybean, rice and corn flours and starches.

U.S. Pat. No. 4,451,491 discloses a mix for the preparation of bread and cake products. The mix comprises a non-wheat-based starch obtained from corn flour, rice flour, soybean flour, potato flour, tapioca flour, cassava flour, sweet potato flour and yams, a gluten-substitute gum selected from the group consisting of xanthan gum, guar gum, locust-bean gum, alginate, pre-gelatinized starch and carboxy-methylcellulose, an emulsified-fat and a powdered whipping agent selected from the group consisting of spray dried margarine, spray dried butter, spray dried cream or a vegetable lipid whipping agents. The bread or cake products are produced in a substantial absence of wheat flour.

The mix also can be supplemented by a binding agent selected from the group consisting of gelatin, instant gelatin, agar-agar and carrageen.

U.S. Pat. No. 4,481,222 discloses dry mixes for the preparation of baked goods having yeasty flavor that do not require dough kneading or lengthy fermentation steps. Such mixes comprise flour, chemical leavening agents, active dry yeast, and a selected gum mixture comprising propylene glycol alginate, and a member selected from the group consisting of karaya gum, guar gum, xanthan gum, carboxy-methyl cellulose, carrageen gum, and mixtures thereof. Baked goods prepared from dough made from the dry mixes herein require no kneading step. After a shortened fermentation step, the dough can be baked in a conventional manner. The resultant baked goods are characterized by high specific volume and a bread-like consistency and texture. However, flour containing 8% gluten is the preferred material in the procedure. The gum combination used seeks to compensate for the loss of gluten in the process and enables the use of limited kneading times without loss of consistency.

### SUMMARY OF THE INVENTION

The present invention provides gluten-free bread having the same appearance as ordinary bread. The gluten-free bread is light and porous, is wholesome to taste, and has an elastic crumb and a crisp crust, thus being amenable to immediate introduction to the consumer as it represents an advance in quality and acceptability compared to other alternative gluten-free types of bread.

In the present invention a mixture and method for preparing gluten-free bread are provided which enable an easy, rapid and inexpensive procedure for obtaining wholesome and nourishing gluten-free bread. For this bread, a dry mixture comprising a gel-forming plant material, a leavening agent such as yeast or a chemical leavening agent, a foam forming material such as egg albumin, and a grain or seed flour such as a naturally derived gluten-free flour and water are combined to prepare dough which can be baked promptly after mixing obviating the conventional kneading process and fermentation delay. The ingredients may conveniently be divided into two dry portions. The first portion of the dry mixture comprising gel-forming plant material, leavening agent and a foam forming agent, when water is added, provides a binder that is then mixed with a second portion of the dry mixture comprising one or more kinds of naturally derived gluten-free flour. Alternatively all dry ingredients can be combined with water to form dough which is promptly baked.

### DETAILED DESCRIPTION OF THE INVENTION

The invention is carried by making naturally derived gluten-free dough from a dry mixture comprising a gel-forming plant material, a leavening agent such as yeast or a chemical leavening agent, a foam forming material such as egg albumin, and a grain or seed flour such as a naturally derived gluten-free flour mixed with water.

In one embodiment of the present invention, all components of the dry mixture are added together and then mixed with water.

In an alternative embodiment of the present invention, it is convenient and practical to partition the dry mixture into two measured portions wherein the first portion comprises a gel-forming plant material, a leavening agent and a foam forming agent. The second dry portion comprises particular quantities of one or more kinds of naturally derived gluten-free flour, which individually can be used together with the first portion. In this embodiment, the leavening agent or the foam-forming agent, or both of these components can optionally be left out of the measured first dry-mix portion and added to the final mix at the mixing stage when water is added. Alternatively, if the leavening agent is a dry chemical powder such as baking powder, it may conveniently be included in the second flour portion.

An essential component of the dry mixture used in the present invention is the gel-forming plant material. The gel-forming plant material can be any mucilage forming agent well known to those skilled in the art. Preferred in the present invention is that gel-forming plant material comprise psyllium as this offers advantageous properties in processing and in the final product and does not affect the taste as much as other materials such as sodium alginate, xanthan gum, pre-gelatinized starch and carboxy-methylcellulose. Further, most of these alternative gel-forming plant materials do not possess the remarkable ability of psyllium to swell and rapidly form mucilage on addition of water. It is characteristic of psyllium that the water content of the mucilage formed can be highly varied while maintaining the viscous gel rheology.

Psyllium or Ispaghula is the common name used for several members of the plant genus Plantago whose seeds are used commercially for the production of mucilage. Seed produced from P. ovata is known as white psyllium and is the type of seed providing the husks used as an ingredient in this invention. Psyllium is a lipid-lowering agent with reductions seen in blood levels of total cholesterol and low-density lipoprotein (“bad cholesterol”). Psyllium has been used as a laxative and has also been applied in the treatment of diarrhea. The mucilage obtained from psyllium comes from the seed coat. Upon absorbing water, the clear, colorless, mucilaginous gel that forms increases in volume by tenfold or more. Psyllium is mainly used as a dietary fiber, which is not absorbed by the small intestine. Psyllium husks can be obtained from W. Ratje Froeskaller ApS, Kirstinehoej 34, DK-2770 Kastrup. Denmark or alternatively from MATAS Rørmosevej 1, 3450 Allerød.

Used in the present invention, psyllium generates the mucilage used to bind the remaining ingredients without the use of mechanical effort so that light mixing by hand suffices to make a fluid binding portion which is used to make the final dough when the second portion consisting primarily of flour is added. The mucilage prepared from psyllium husks allows great variation in the amount of water added to the solid matter of the dry-mixture. A solid to liquid ratio varying from 2 parts solids to 5 parts water makes a very light highly porous bread while a solid to liquid ratio of 4:5 makes a firm, compact finely-pored bread product. A solid to liquid ratio varying from 2.5:5 to 3.5:5 allows adequate variation in the specific volume of the final bread product according to the consumers' normal requirement and these limits are the preferred bounds of the solids to water ratio.

Another characteristic feature of the dry mixture comprising psyllium mucilage is that it allows for elimination of the traditional fermentation step, also called proving or raising. The mixture of all ingredients, optionally mixed from two dry partitioned portions of the ingredients, when finally mixed with water can de poured into a receptacle such as a bread form or mold and immediately baked in an oven. The final mixture with water forms a viscous slurry in the course of a few minutes and can be formed or alternatively poured in portions onto an oven plate and placed in a cold oven. It is not a requirement of the procedure that the material be fermented or placed directly into a heated oven.

There are a variety of choices for the grain or seed flour used in the dry mixture or the second portion of dry mixture which may be varied according to the preference and choice of the consumer. Whereas the method primarily is directed towards preparation of gluten-free bread, as there is a need therefore, there are no restrictions dictated by the process disclosed on the flour component of the dry mixture. Thus, the grain or seed flour may comprise various products known not to contain gluten, or wheat flour where gluten is removed or reduced or even a normal flour containing higher levels of protein.

The grain or seed flour may further comprise nuts or seeds or kernels of grain, fruit and other desirable supplements at the choice of the consumer.

The dough can also be combined with other foodstuffs and may be packed in these or pack other foodstuffs packed in the dough. The dough may also be used for beignet wherein other foods are packed into the dough and deep-fried.

The procedures of the present invention differ to that disclosed by Kato Susumu in WO2004080186 in that the production of viscous mucilage does not require heating and that a fermentation step is not required. In the present invention, the first portion contains all the ingredients required to make foam and bind the second portion resulting in dough without the use of a kneading step. The ingredients in the second portion of this invention are not restricted to just rice or any particular kind of flour.

The use of egg albumin has also been disclosed in EP0642737. Gluten-free bread is produced from gluten-free flour and beaten eggs and optionally baking powder and baker's yeast. However, the procedure disclosed in EP0642737 demands energetic agitation, which is not required in the present invention either during initial mixing or after the flour is added and the dough produced in the present invention does not require a period of proving or fermentation.

The following nonlimiting examples are provided to further illustrate the present invention.

### EXAMPLES

Using the two-portion dry mix procedure, a pre-batch comprising psyllium, yeast and albumin is made and then used with a wide variety of alternative flours selected by the consumer.

EXAMPLE 1

| | |
|---|---|
| Part A | |
| Dried | 6 gm. |
| Bakers | |
| Yeast | |
| Chicken | 12 gm. |
| Egg | |
| Albumin | |
| Psyllium | 13 gm. |
| Part B | |
| Buckwheat | 100 gm. |
| kernels | |
| Rice | 40 gm. |
| flour | |
| Maize | 40 gm. |
| flour | |
| Sesame | 40 gm. |
| flour | |
| Lin flour | 40 gm. |
| Water | 500 gm |

For this dry mixture embodiment two mixing procedures can be used. Mixing Procedure 1.

Duration 20 minutes.

500 ml water is added to the yeast, albumin and psyllium. After 15 minutes the mixture is whipped to foam and the flour and grain is added.

Mixing Procedure 2.

All components are mixed dry and 500 ml. of water added. The mix coagulates in 5 to 7 minutes without any further mixing so that the material is not agitated or whipped subsequent to water addition.

The resulting dough can then be added to a baking form and baked immediately, without delay for fermentation, in the conventional manner.

EXAMPLE 2

| | |
|---|---|
| Part A | |
| Baking Powder | 6 gm. |
| Chicken Egg Albumin | 12 gm. |
| Psyllium | 13 gm. |
| Part B | |
| Rice flour | 100 gm. |
| Buckwheat flour | 50 gm. |
| Maize flour | 50 gm. |
| Sesame flour | 60 gm. |
| Millet flour | 40 gm. |
| Water | 500 gm. |

Mixing Procedure 2 as disclosed in Example 1 was used with this exemplary dry mixture. All components are mixed dry and 500 ml. of water added. The form and the coagulated contents were put into an oven for baking after the 5 to 7 minutes coagulation period. The resulting dough was baked immediately, without delay for fermentation, in the conventional manner.

EXAMPLE 3

| | |
|---|---|
| Part A | |
| Baking Powder | 6 gm. |
| Chicken Egg Albumin | 12 gm. |
| Psyllium | 13 gm. |
| Part B | |
| Lentil flour | 100 gm. |
| Buckwheat kernels | 100 gm. |
| Buckwheat flour | 50 gm. |
| Sesame flour | 40 gm. |
| Lin flour | 100 gm. |
| Black poppy seed | 20 gm. |
| Water | 600 gm |

Mixing procedure 1 as disclosed in Example 1 was used.

What is claimed is:

1. A dry mixture composition for making gluten-free dough for bread, said dry mixture composition comprising a gel-forming plant material, a leavening agent, a foam forming ingredient, and one or more kinds of flour.

2. The dry mixture composition of claim 1 wherein the gel-forming plant material comprises seeds or bran or husks of Plantago known as Psyllium or Ispaghula.

3. The dry mixture composition of claim 1 wherein the foam forming agent comprises albumin derived from eggs.

4. The dry mixture composition of claim 1 wherein the leavening agent is selected from a group of agents comprising yeast or chemical leavening agents.

5. The dry mixture composition of claim 1 wherein the flour is gluten-free flour.

6. The dry mixture composition of claim 1 wherein the dry ingredients are partitioned into a first portion and a second portion.

7. A method for preparing the dry mixture composition of claim 6, wherein the first portion comprises a leavening agent, a gel-forming agent and a foam-forming agent and a second portion comprises one or more kinds of flour.

8. A method for preparing the dry mixture composition of claim 6, wherein the first portion comprises the gel-forming agent and the foam-forming agent and the second portion comprises one or more kinds of flours and the leavening agent.

9. A method for preparing the dry mixture composition of claim 6, wherein the first portion comprises the gel-forming agent and the leavening agent and the second portion comprises one or more kinds of flours and the foam-forming agent.

10. A method for preparing the dry mixture composition of claim 6, wherein the first portion comprises the gel-forming agent and the second portion comprises one or more kinds of flours, the foam-forming agent and the leavening agent.

11. A method for preparing dough using a two-component dry composition according to claim 6, said method comprising mixing the first portion with water and agitating to make a gel; and mixing the gel with the second portion to form a dough.

12. A method for preparing dough using the dry mixture composition of claim 1 wherein the dry mixture composition is mixed with water so that a dough is formed.

13. A method for preparing bread wherein dough prepared in accordance with the method of claim 11 is baked without delay after mixing.

14. A method for preparing bread wherein dough prepared in accordance with the method of claim 12 is baked without delay after mixing.

15. Raw, preserved or baked dough prepared according to the method of claim 11.

16. Raw, preserved or baked dough prepared according to the method of claim 12.

17. Raw, preserved or baked dough prepared from the dry mixture composition of claim 1.
